(19) United States
(12) Patent Application Publication
(10) Pub. No.: US 2006/0029013 A1
(43) Pub. Date: Feb. 9, 2006

(54) System and method for remote controlling of a media player

(75) Inventors: De-Hua Dang, Shenzhen (CN); Ming-Xiong Liao, Shenzhen (CN); Gang Liu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD, Tu-Cheng City (TW)

(21) Appl. No.: 11/168,811

(22) Filed: Jun. 28, 2005

(30) Foreign Application Priority Data
Jul. 9, 2004 (TW) 93120619

(51) Int. Cl. H04J 3/08

(52) U.S. Cl. 370/326

(57) ABSTRACT

A system for remote controlling of a media player includes a host computer (1), a display (2), and a remote controller (3). The remote controller is used for inputting commands for controlling a media player (8), and generating consumer infrared (CIR) signals according to the commands. The host computer includes: a CIR signal processing module (14) for receiving and modulating the CIR signals from the remote controller; an audio DJ data processing module (15) for analyzing and transforming the CIR signals to audio DJ data, and sending the audio DJ data to control the media player; and a Liquid Crystal Display (LCD) controlling module (16) for receiving and controlling media information to be displayed on an LCD panel (10). A related method is also disclosed.

### BACKGROUND OF THE INVENTION

1. Field of the Invention

The present invention relates to systems and methods for remote controlling of a computer program, and particularly to a system and method for remote controlling of a media player in an operation system by utilizing an infrared radiation technique.

2. General Background

It is known that Infrared Radiation (IR) remote controllers have become required accessories of household appliances such as TV sets and stereos. IR remote controllers can be categorized according to their implementations into two systems: Consumer IR (CIR) system and Fast IR (FIR) system. CIR is economical, with a short control range. FIR is more costly, but with a rather long control range. The cost and effective control range are to be weighted against each other in light of the appliances concerned and operating conditions involved, so that the manufacturer can choose which system is to be utilized. For general household appliances, it is CIR that is commonly utilized.

In the field of information appliances, computers implemented with IR remote control functionality are becoming more and more popular. U.S. Pub. No. 20020044321 published on Apr. 18, 2002 and entitled “Infrared Radiation Remote Control System for a Portable Computer”, discloses a remote control system for a portable computer with a built-in IR receiver for receiving IR signals emitted from a remote controller. The system comprises: chipsets connecting a Central Processing Unit (CPU) to the IR receiver and to a serial port; a circuit connecting the IR receiver to the serial port; and software for determining whether to switch short the circuit by transmitting a first signal to the circuit and whether to switch open the circuit by transmitting a second signal to the circuit.

However, the control system described above requires a CIR receiver, a serial port and a circuit. In addition, the system needs to be equipped with one CIR receiver for receiving remote control signals from a CIR remote controller. These greatly increase the burden placed on the operating hardware, and make the system difficult to implement.

What is needed, therefore, is a system for remote controlling of information appliances, such as a media player loaded in a Windows operating system (OS) of a computer, through fewer hardware and simple software.

Similarly, what is also needed is a method for remote controlling of information appliances, such as a media player loaded in a Windows OS of a computer, through fewer hardware and simple software.

### SUMMARY

A system for remote controlling of a media player in accordance with a preferred embodiment includes a host computer, a display, a remote controller, an audio output device, a keyboard, a mouse, and an LCD panel. The remote controller is used for users to input commands for controlling the media player, and for generating Consumer Infrared (CIR) signals according to the commands. The host computer comprises a Central Processing Unit (CPU), a South Bridge, a super I/O chipset, a CIR signal processing module, an audio DJ data processing module, and an LCD controlling module. The CIR signal processing module is used for receiving and processing the CIR signals from the remote controller. The audio DJ signal processing module is used for analyzing and transforming the CIR signals to audio DJ data, and sending the audio DJ data through the south bridge to invoke media player. The LCD controlling module is used for transmitting and controlling the media information to be displayed on the LCD panel. The LCD panel is enchased on a front panel of the host computer, for displaying the media information. The media information includes song titles, playing statues, played time, volume, and system time.

Another preferred embodiment provides a method for remote controlling of a media player loaded in an operating system (OS) of a computer, the method comprising the steps of: (a) inputting commands for controlling the media player; (b) generating CIR signals according to the commands; (c) receiving the CIR signals and modulating the CIR signals to CIR data; (d) transforming the CIR data to audio DJ data; (e) sending the audio DJ data to the media player; (f) controlling the media player to respond to the audio DJ data; (g) generating and transmitting media information to an LCD panel; and (h) displaying the media information on the LCD panel.

Step (c) described above comprises: (c1) configuring parameters of all I/O ports of the computer to receive the CIR signals, and storing execution statuses of original threads; (c2) configuring base addresses of registers which are capable of receiving the CIR signals, and selecting a system interrupt service mode; (c3) modulating the CIR signals to CIR data, and running a First In and First Out (FIFO) thread for transmitting the CIR data; (c4) clearing data of a FIFO queue, and setting address values of the registers as digital “1”; (c5) waiting for system interrupt information; (c6) determining whether the system interrupt information is CIR data; (c7) storing the CIR data if the system interrupt information is CIR data; (c8) returning to step (c5), if the system interrupt information is not CIR data; (c9) determining whether to continue to receive the CIR data; (c10) configuring parameters to disable the I/O ports to receive the CIR signals and re-executing the original threads, if it is determined to not continue to receive the CIR data; and (c11) returning to step (c5), if it is determined to continue to receive the CIR data.

Step (e) described above comprises: (e1) executing an audio DJ service thread; (e2) determining whether there are audio DJ data; (e3) setting the audio DJ service thread in a state of sleep, if there are no audio DJ data; (e4) storing the audio DJ data in a First In and First Out (FIFO) queue, if there are audio DJ data; and (e5) loading a Hook( ) function to obtain the audio DJ data from the FIFO queue.

Other objects, advantages and novel features of the embodiments will be drawn from the following detailed description with reference to the attached drawings, in which:

### BRIEF DESCRIPTION OF THE DRAWINGS

FIG. 1 is a schematic diagram of a computer system for remote controlling of a media player according to a preferred embodiment of the present invention;

FIG. 2 is a schematic diagram of a remote controller of the system of FIG. 1;

FIG. 3 is a schematic diagram of internal infrastructure of a host computer of the system of FIG. 1;

FIG. 4 illustrates main data interchanges between components of the system of FIG. 1;

FIG. 5 is a schematic diagram of a layered structure of an audio DJ processing module of the host computer of FIG. 3;

FIG. 6 is a flowchart of a preferred method for processing CIR signals by implementing the system of FIG. 1; and

FIG. 7 is a flowchart of a preferred method for remote controlling of a media player of by implementing the system of FIG. 1.

### DETAILED DESCRIPTION OF THE EMBODIMENTS

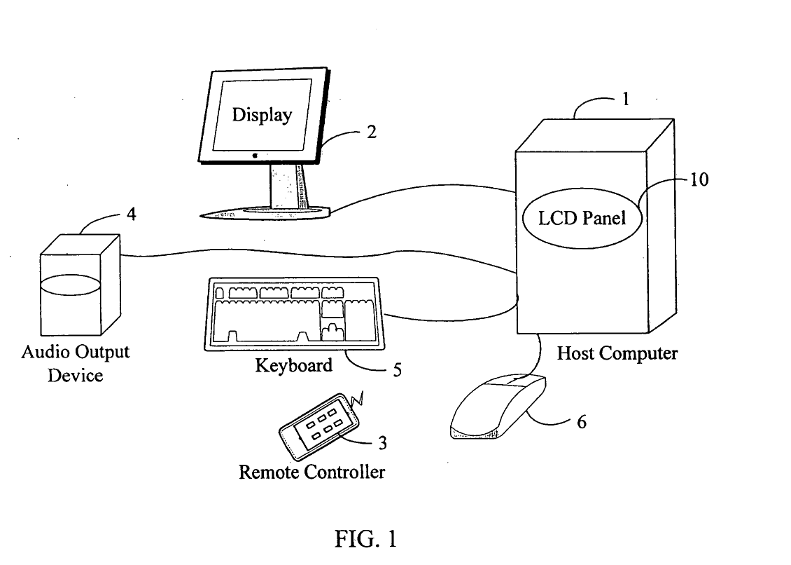

FIG. 1 is a schematic diagram of a computer system for remote controlling of a media player (hereinafter, “the system”) according to a preferred embodiment of the present invention. The system includes a host computer 1, a display 2, a remote controller 3, an audio output device 4, a keyboard 5, a mouse 6, and a Liquid Crystal Display (LCD) panel 10. The LCD panel 10 is enchased on a front panel of the host computer 1, for displaying media information, such as song titles, playing status, played time, volume and system time. The display 2 can also be used for displaying the media information. The remote controller 3 is used for users to input commands of controlling the media player, and generating Consumer Infrared (CIR) signals according to the commands.

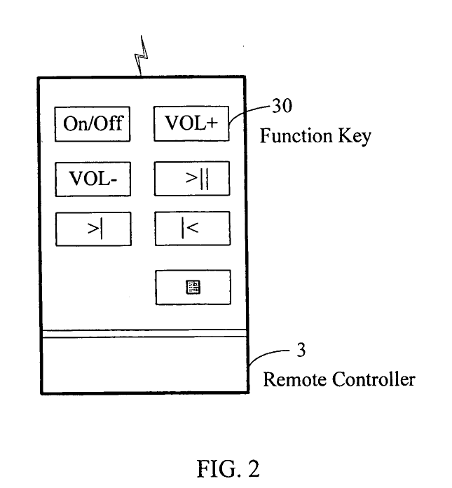

FIG. 2 is a schematic diagram of the remote controller 3. The remote controller 3 typically includes seven function keys 30: a song playing on/off key (On/Off), a volume increasing key (VOL+), a volume decreasing key (VOL−), a song list speeding key (>μ), a song forward key (>|), a song back key (<|), and a song play/pause key (▪). Table 1 lists command encodings of these function keys 30 and their corresponding functions.

TABLE 1

| Sequence Number | Encoding | Function | Icon |
|---|---|---|---|
| K1 | 0C | Play on/off song | On/Off |
| K2 | 0B | Increase volume | VOL+ |
| K3 | 0A | Decrease volume | VOL− |
| K4 | 23 | Speed song list | >∥ |
| K5 | 25 | Forward song | >\| |
| K6 | 28 | Back song | <\| |
| K7 | 29 | Play/Pause song | ▪ |

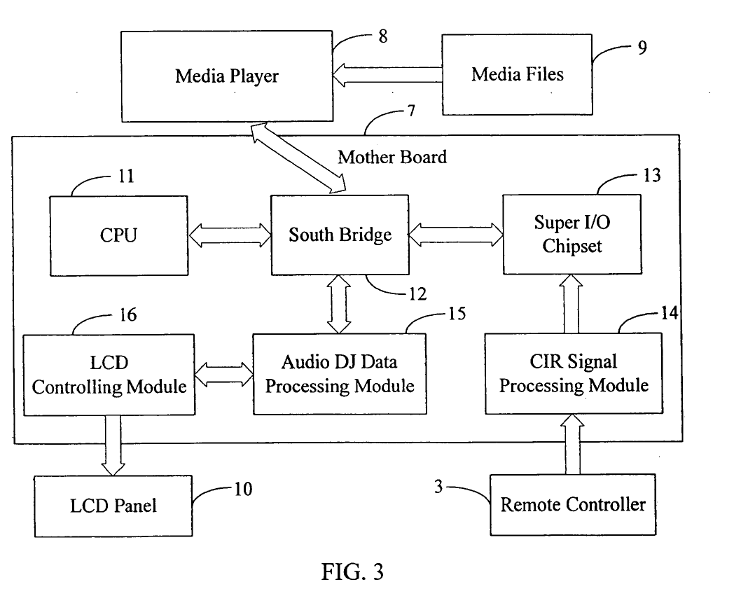

FIG. 3 is a schematic diagram of internal infrastructure of the host computer 1 in accordance with the preferred embodiment. A motherboard 7 of the host computer 1 includes a Central Processing Unit (CPU) 11, a South Bridge 12, a super I/O chipset 13, a CIR signal processing module 14, an audio DJ data processing module 15, and an LCD controlling module 16. A media player 8 is installed in an operation system (OS) of the host computer 1, such as a Windows media player, an MP3, or a Real-player. Media files 9 are stored in CD/DVD drives or hard disk drives of the host computer 1 (not shown), for providing media data to the media player 8. The connections of these components are clearly illustrated in FIG. 3. The CIR signal processing module 14 is used for receiving and processing CIR signals from the remote controller 3. The audio DJ signal processing module 15 is used for analyzing and transforming the CIR signals to audio DJ data, and transmitting the audio DJ data to the south bridge 12, in order to invoke and control the media player 8 to play the media files 9. The LCD controlling module 16 is used for transmitting media information received from the audio DJ signal processing module 15 to the LCD panel 10 for displaying.

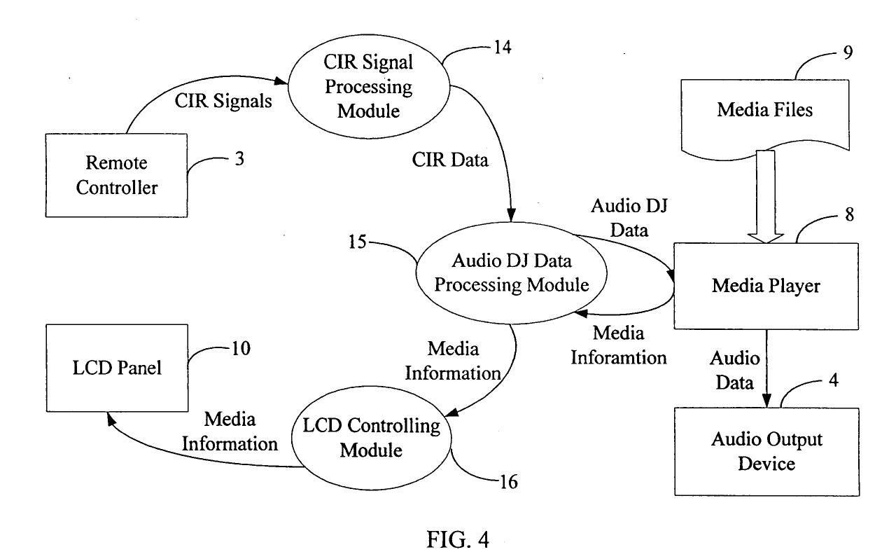

FIG. 4 illustrates main data interchanges between various components of the system. The remote controller 3 generates CIR signals according to commands for controlling the media player 8 inputted by a user, and emits the CIR signals to the CIR signal processing module 14. The CIR signal processing module 14 processes the CIR signals to CIR data, and transmits the CIR data to the south bridge 12 through the super I/O chipset 13. Meanwhile, the CIR data are stored in a main memory of the south bridge 12. The audio DJ processing module 15 obtains the CIR data from the main memory, and modulates the CIR data to audio DJ data for controlling the media player 8 to play the media files 9. The media player 8 reads media data from the media files 9, and outputs media information to the audio DJ data processing module 15. Simultaneously, the media player 8 outputs audio data to the audio output device 4. The LCD controlling module 16 receives the media information from the audio DJ data processing 15, and controls the LCD panel 12 to display the media information. The media information includes song titles, playing status, played time, volume and system time.

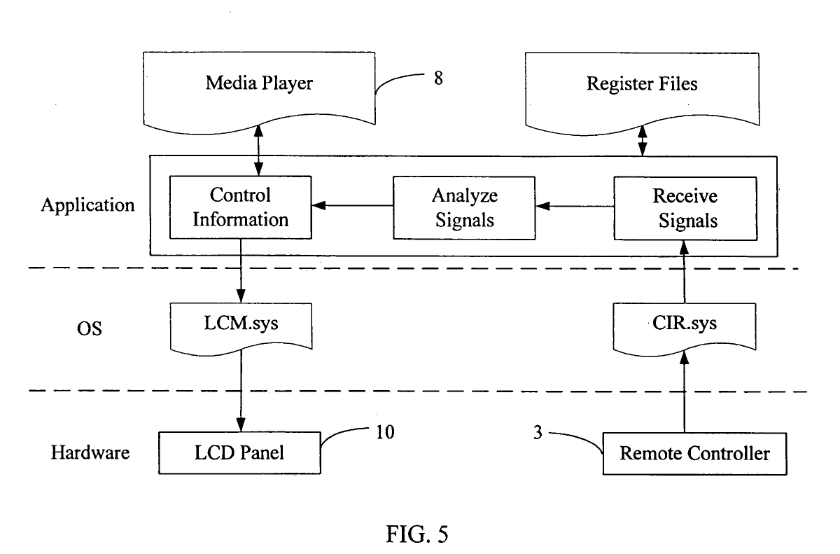

FIG. 5 is a schematic diagram of layered structure of the audio DJ data processing module 15. The audio DJ processing module 15 performs three main functions including: receiving CIR signals, analyzing and decoding the CIR signals, and invoking and controlling the media player 8. The remote controller 3 and the LCD panel 10 locate in a hardware layer. CIR.sys and LCM.sys locate in an OS layer. CIR.sys is a special document used for processing the CIR signals, and LCM.sys is another special document used for processing and controlling media information to be displayed on the LCD panel 10. The media player 8 and register files locate in an application layer. The remote controller 3 first generates CIR signals according to user-input commands for controlling the media player 8, and transmits the CIR signals to the OS layer. The Windows OS automatically modifies the register files to respond to the commands. Simultaneously, the audio DJ data processing module 15 executes CIR.sys to transform the CIR signals to audio DJ data, transmits the audio DJ data to the media player 8, and transmits the media information to LCM.sys of the OS layer. Then the LCD controlling module 16 executes LCM.sys to control the LCD panel 10 to display the media information.

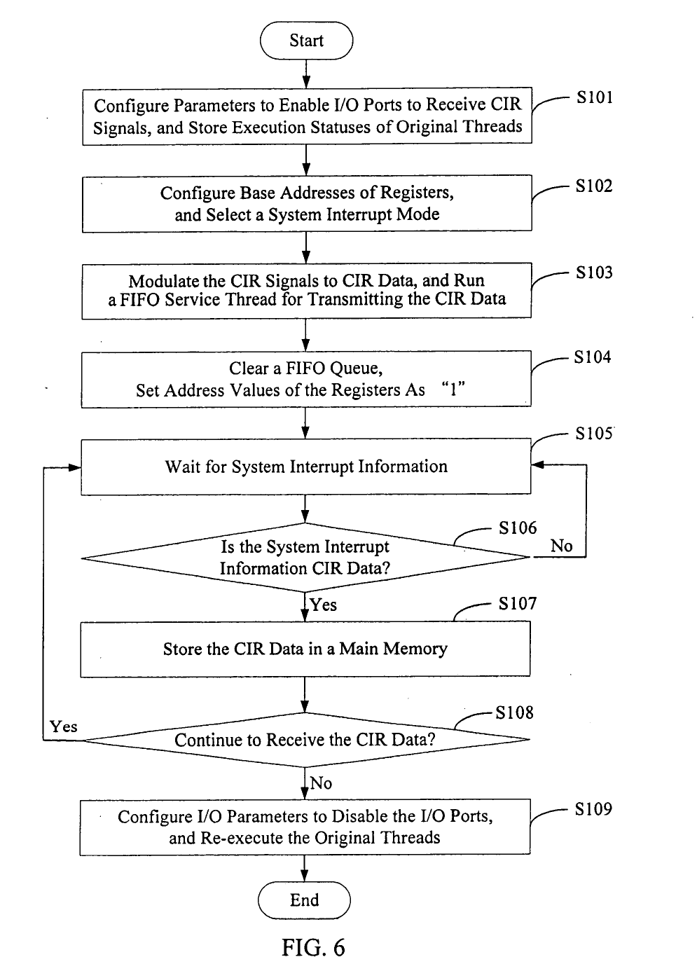

FIG. 6 is a flowchart of a preferred method for processing CIR signals by implementing the system. In step S101, the CPU 11 configures parameters of the super I/O chipset 13, in order to enable all I/O ports to receive CIR signals from the CIR signal processing module 14, and stores execution statuses of original threads. Each original thread is a program being executed in an OS (i.e. Windows OS) of the host computer 1. In step S102, the CPU 11 configures base addresses of registers which are capable of receiving the CIR signals, and selects an interrupt mode to invoke a system interrupt service. In step S103, the CIR signal processing module 14 modulates the CIR signals received from the remote controller 3 to CIR data, and the CPU 11 runs a First In and First Out (FIFO) thread for transmitting the CIR data. In step S104, the CPU 11 clears data of a FIFO queue, and sets address values of the registers as “1.” In the preferred embodiment, the registers are named as register REXN, register REXEND and register RXACT. In step S105, the CIR signal processing module 14 waits for system interrupt information. In step S106, the CIR signal processing module 14 determines whether the system interrupt information is CIR data. If the system interrupt information is not CIR data, the procedure returns to step S105 described above. Otherwise, if the system interrupt information is CIR data, in step S107, the CPU stores the CIR data in a main memory. Then in step S108, the CIR signal processing module 14 determines whether to continue to receive the CIR data. If the CIR signal processing module 14 determines not to continue to receive the CIR data, in step S109, the CPU 11 configures parameters of the super I/O chipset 13 in order to disable the I/O ports to receive the CIR signals, and re-executes the original threads according to previously stored execution statuses of the original threads. Otherwise, if the CIR signal processing module 14 continues to receive the CIR data, the procedure returns to step S105 described above.

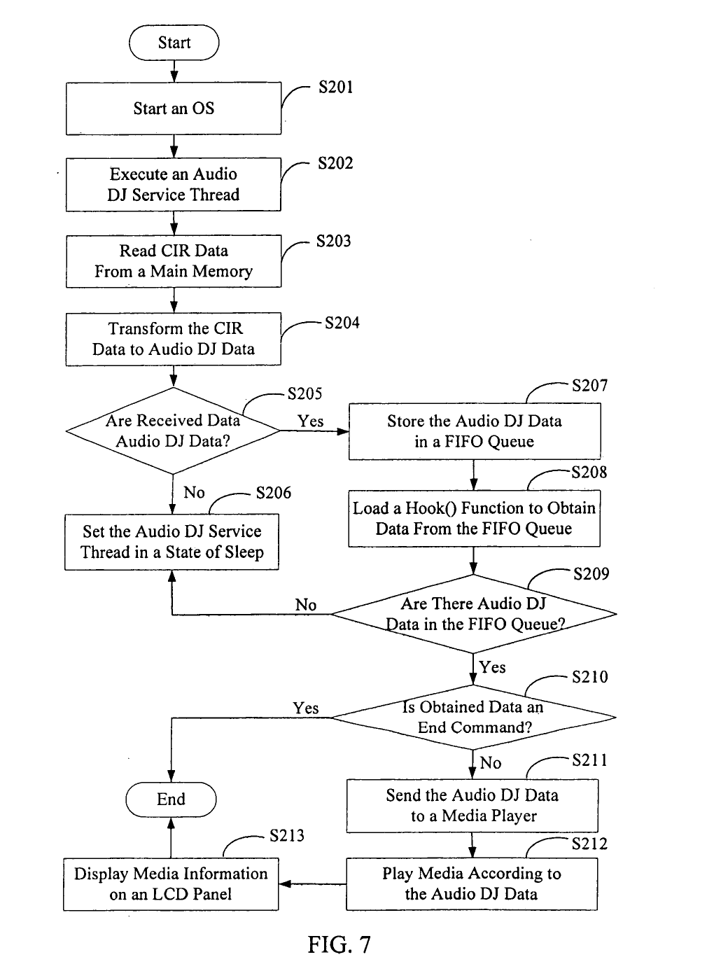

FIG. 7 is a flowchart of the preferred method for remote controlling of the media player 8. In step S201, the host computer 1 starts an OS, such as a Windows OS. In step S202, the Windows OS executes an audio DJ service thread. In step S203, the audio DJ data processing module 15 reads the CIR data from the main memory. In step S204, the audio DJ data processing module 15 transforms the CIR data to audio DJ data. In step S205, the audio DJ data processing module 14 determines whether the received data are audio DJ data. If the received data are not audio DJ data, in step S206, the audio DJ service thread is set in a state of sleep to wait for the audio DJ data. Otherwise, if the received data are audio DJ data, in step of S207, the audio DJ service thread stores the audio DJ data in a FIFO queue. In step S208, the Windows OS loads a Hook( ) function to obtain data from the FIFO queue. Then in step S209, the audio DJ data processing module 15 determines whether there are audio DJ data in the FIFO queue. If there are no audio DJ data in the FIFO queue, the procedure returns to step S206 described above. Otherwise, if there are audio DJ data in the FIFO queue, in step S210, the audio DJ data processing module 15 determines whether the obtained audio DJ data is an end command for stopping the media player 8. If the obtained audio DJ data is an end command, the procedure is ended. Otherwise, if the obtained audio DJ data is not an end command, in step S211, the audio DJ service thread sends the obtained audio DJ data to the media player 8. In step S212, the media player 8 plays media according to the obtained audio DJ data, and transmits the media information to the LCD controlling module 16 through the audio DJ data processing module 15. In step S213, the LCD controlling module 16 controls the LCD panel 10 to display the media information. The media information includes song titles, playing status, played time, volume, and system time.

Although the present invention has been specifically described on the basis of a preferred embodiment and preferred method, the invention is not to be construed as being limited thereto. Various changes or modifications may be made to the embodiment and method without departing from the scope and spirit of the invention.

We claim:

1. A system for remote controlling of a media player loaded in an operating system of a computer, the system comprising:
a remote controller for inputting commands for controlling the media player, and generating Consumer Infrared (CIR) signals according to the commands; and
a host computer comprising:
a CIR signal processing module for receiving and processing the CIR signals from the remote controller;
an audio DJ signal processing module for analyzing and transforming the CIR signals to audio DJ data, and transmitting the audio DJ data in order to invoke and control the media player; and
a Liquid Crystal Display (LCD) controlling module for transmitting and controlling an LCD panel of the host computer to display media information.

2. The system according to claim 1, wherein the remote controller comprises seven function keys: a song playing on/off key, a volume increasing key, a volume decreasing key, a song list speeding key, a song forward key, a song back key, and a song play/pause key.

3. The system according to claim 1, wherein the CIR signals are Infrared Radiation signals.

4. The system according to claim 1, wherein the LCD panel is enchased on a front panel of the host computer.

5. A computer-based method for remote controlling of a media player loaded in an operating system of a computer, the method comprising the steps of:
inputting commands for controlling the media player;
generating Consumer Infrared (CIR) signals according to the commands;
receiving the CIR signals and modulating the CIR signals to CIR data;
transforming the CIR data to audio DJ data;
sending the audio DJ data to the media player;
invoking the media player to respond to the audio DJ data;
transmitting media information included in the audio DJ data to a display; and
displaying the media information on the display.

6. The method according to claim 5, wherein the CIR signals are Infrared Radiation signals.

7. The method according to claim 5, wherein the media information include song titles, playing status, played time, volume, and system time.

8. The method according to claim 5, wherein the step of receiving the CIR signals and modulating the CIR signals to CIR data comprises:
configuring parameters of all I/O ports of the computer to receive the CIR signals, and storing execution statuses of original threads;
configuring base addresses of registers which are capable of receiving the CIR signals, and selecting a system interrupt service mode;
modulating the CIR signals to CIR data, and running a First In and First Out (FIFO) thread for transmitting the CIR data;
clearing data of a FIFO queue, and setting address values of the registers as digital waiting for system interrupt information;
determining whether the system interrupt information is CIR data;
storing the CIR data if the system interrupt information is CIR data;
returning to the waiting step, if the system interrupt information is not CIR data;
determining whether to continue to receive the CIR data;
configuring parameters to disable the I/O ports to receive the CIR signals, and re-executing the original threads, if it is determined to not continue to receive the CIR data; and
returning to the waiting step, if it is determined to continue to receive the CIR data.

9. The method according to claim 5, wherein the step of sending the audio DJ data to the media player comprises the steps of:
executing an audio DJ service thread;
determining whether there are audio DJ data;
storing the audio DJ data in a First In and First Out (FIFO) queue, if there are audio DJ data; and
obtaining the audio DJ data from the FIFO queue.

10. The method according to claim 9, wherein the step of determining whether there are audio DJ data comprises the step of setting the audio DJ service thread in a state of sleep to wait for the audio DJ data, if there are no audio DJ data.

11. A method for remote controlling of a media player loaded in an operating system, the method comprising the steps of:
remotely retrieving controllable signals from a user of said operating system according to commands of said user;
translating said remotely-transmissible, controllable signals to digitally recognizable data;
invoking said media player in response to said data; and
displaying media information from said media player in response to said data.

12. The method according to claim 11, wherein said remotely-transmissible, controllable signals are Consumer Infrared (CIR) signals, and said CIR signals are translatable to audio DJ data as said digitally recognizable data by means of modulating said CIR signals to CIR data and subsequently transforming said CIR data to said audio DJ data.
